(19) United States
(12) Patent Application Publication
(10) Pub. No.: US 2012/0290772 A1
(43) Pub. Date: Nov. 15, 2012

(54) STORAGE CONTROL APPARATUS FOR CONTROLLING DATA WRITING AND DELETION TO AND FROM SEMICONDUCTOR STORAGE DEVICE, AND CONTROL METHOD AND STORAGE MEDIUM THEREFOR

(75) Inventors: Kohei Asano, Yokohama-shi (JP); Keishi Inaba, Yokohama-shi (JP); Koji Shimizu, Tokyo (JP); Kiyokazu Umimura, Kawasaki-shi (JP); Yuji Naya, Kawasaki-shi (JP); Yuichi Konosu, Saitama-shi (JP)

(73) Assignee: CANON KABUSHIKI KAISHA, Tokyo (JP)

(21) Appl. No.: 13/466,484

(22) Filed: May 8, 2012

(30) Foreign Application Priority Data
May 9, 2011 (JP) 2011-104365

(51) Int. Cl. G06F 12/00

(52) U.S. Cl. 711/103; 711/E12.008

(57) ABSTRACT

A storage control apparatus capable of properly deleting data dispersedly stored in a semiconductor storage device with wear leveling. The storage control apparatus converts an address given with a write instruction, among addresses of the semiconductor storage device, into another address, holds address conversion information that associates the before- and after-conversion addresses with each other, and controls the semiconductor storage device to write data into the after-conversion address. When a delete instruction is given, the storage control apparatus controls the semiconductor storage device in accordance with the address conversion information to delete data stored in an after-conversion address associated with an address given with the delete instruction.

### BACKGROUND OF THE INVENTION

1. Field of the Invention

The present invention relates to a storage control apparatus for controlling data writing and deletion to and from a semiconductor storage device such as a flash memory, and relates to a control method for the storage control apparatus and a storage medium storing a program for causing a computer to execute the control method.

2. Description of the Related Art

Recently, there has been used a semiconductor storage device that includes a flash memory and a flash memory controller for controlling the flash memory. Since the flash memory is limited in the number of writing times and in the number of deletion times due to its internal structure, load balancing (wear leveling) is performed to prevent concentrated writing to a particular portion of the flash memory.

Among various wear leveling methods, there is often used a wear leveling method where an address is operated at the time of writing to the flash memory. With this wear leveling method, the flash memory controller has a map that indicates a relation between physical block addresses (PBAs) of the flash memory and logical block addresses (LBAs) of a file system. The flash memory controller assigns a less-frequently written PBA in response to a write instruction from a host, and rewrites information about connection between PBA and LBA each time assigning a new PBA.

In a case that data is written into PBA(1) corresponding to LBA(1) given with the write instruction, and the write instruction is given to the same LBA(1) from the host, the flash memory controller controls the flash memory to write data into PBA(2) different from PBA (1) and rewrites the connection information associating LBA(1) with PBA(1) to new connection information associating LBA(1) with PBA(2) (see, for example, Japanese Laid-open Patent Publication No. 2001-067258).

With this wear leveling method, information about connection between LBA and PBA is rewritten each time the write instruction is given to the same LBA. Thus, only the latest connection information is present on the map.

Accordingly, when a delete instruction is given to the LBA from the host, data written in the PBA that is indicated by the latest connection information can be deleted, however, one or more pieces of data previously written in one or more PBAs that are unknown from the latest connection information cannot be deleted and are left remaining on the flash memory, which poses a problem.

### SUMMARY OF THE INVENTION

The present invention provides a storage control apparatus capable of properly deleting data dispersedly stored in a semiconductor storage device with wear leveling, and provides a control method for the storage control apparatus and a storage medium storing a program for causing a computer to execute the control method.

According to one aspect of this invention, there is provided a storage control apparatus that controls data writing and deletion to and from a semiconductor storage device based on physical addresses in the semiconductor storage device and logical addresses made to respectively correspond to the physical addresses, comprising a conversion unit configured to convert a logical address given with a write instruction into another logical address, the conversion unit converting a same logical address to a different logical address at each conversion in a case where the write instruction is given multiple times to the same logical address, a holding unit configured to hold address conversion information that associates the logical address given with the write instruction with an after-conversion logical address converted from the logical address by the conversion unit, the holding unit holding plural pieces of address conversion information that associate a same logical address with respective ones of different after-conversion logical addresses in a case where the write instruction is given multiple times to the same logical address, a write control unit configured to control the semiconductor storage device to write data into a physical address corresponding to the after-conversion logical address converted by the conversion unit from the logical address given with the write instruction, and a deletion control unit configured to control the semiconductor storage device to delete data stored in a physical address corresponding to an after-conversion logical address converted from a logical address given with a delete instruction, the delete control unit controlling the semiconductor storage device to delete pieces of data stored in respective ones of physical addresses respectively corresponding to different after-conversion logical addresses respectively indicated in plural pieces of address conversion information in a case where the plural pieces of address conversion information are held in the holding unit.

According to another aspect of this invention, there is provided a storage control apparatus that controls data writing and deletion to and from a semiconductor storage device comprising a conversion unit configured to convert an address given with a write instruction, among addresses representing storage areas of the semiconductor storage device, into another logical address, a holding unit configured to hold address conversion information that associates the address given with the write instruction with an after-conversion address converted from the logical address by the conversion unit, a write control unit configured to control the semiconductor storage device to write data into the after-conversion address converted by the conversion unit from the address given with the write instruction, and a deletion control unit configured to control the semiconductor storage device in accordance with the address conversion information held by the holding unit to delete data stored in an after-conversion address associated with an address given with a delete instruction in a case where the delete instruction is given to the address previously given with the write instruction.

With this invention, it is possible to properly delete data dispersedly stored in the semiconductor storage device with wear leveling.

Further features of the present invention will become apparent from the following description of exemplary embodiments with reference to the attached drawings.

### BRIEF DESCRIPTION OF THE DRAWINGS

FIG. 1 is a block diagram schematically showing an address conversion apparatus serving as a storage control apparatus according to a first embodiment of this invention;

FIGS. 2A to 2D are views each showing an address conversion table for use by the address conversion apparatus and each showing a correspondence relation among before- and after-conversion logical addresses on the file system and physical addresses of the flash memory;

FIG. 3 is a flowchart showing procedures of a write process performed by the address conversion apparatus;

FIG. 4 is a flowchart showing procedures of a readout process performed by the address conversion apparatus;

FIG. 5 is a flowchart showing procedures of a delete process performed by the address conversion apparatus;

FIG. 6 is a block diagram schematically showing the construction of a storage control apparatus according to a second embodiment of this invention;

FIG. 7 is a flowchart showing procedures of a write process performed by a flash memory controller shown in FIG. 6;

FIG. 8 is a flowchart showing procedures of a readout process performed by the flash memory controller;

FIG. 9 is a flowchart showing procedures of a delete process performed by the flash memory controller;

FIG. 10 is a block diagram schematically showing the construction of a storage control apparatus according to a third embodiment of this invention; and

FIG. 11 is a flowchart showing procedures of a write process performed by an address conversion apparatus according to a fourth embodiment of this invention.

### DESCRIPTION OF THE EMBODIMENTS

The present invention will now be described in detail below with reference to the drawings showing preferred embodiments thereof.

A storage control apparatus according to each of first to fourth embodiments of this invention (described below) executes data writing and deletion to and from a semiconductor storage device based on physical addresses of the semiconductor storage device and logical addresses made to respectively correspond to the physical addresses, whereby data are dispersedly written into the semiconductor storage device with wear leveling and the dispersedly stored data are deleted from the semiconductor storage device.

### First Embodiment

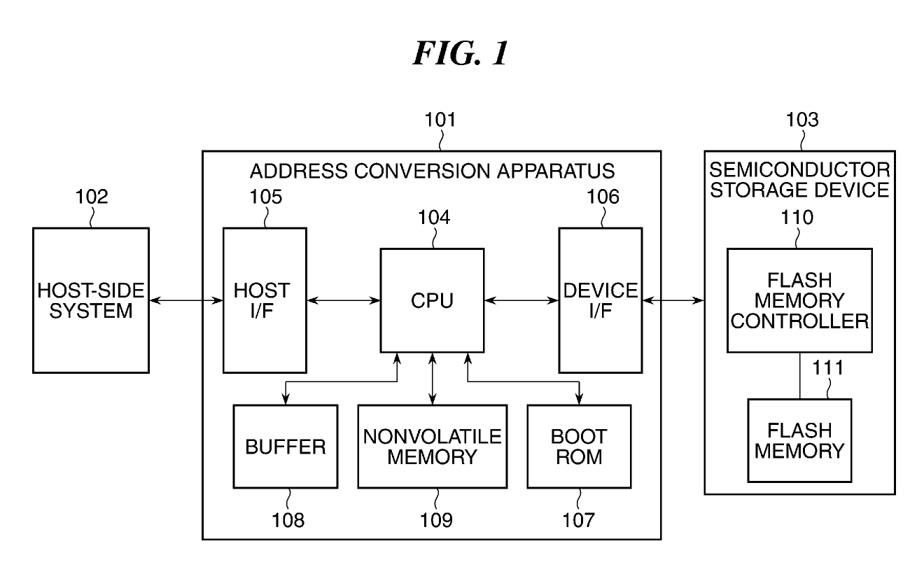

FIG. 1 schematically shows, in block diagram, the construction of an address conversion apparatus serving as a storage control apparatus according to a first embodiment of this invention.

In FIG. 1, reference numeral 101 denotes the address conversion apparatus interposed between a host-side system 102 and a semiconductor storage device 103. The address conversion apparatus 101 includes a CPU 104, boot ROM 107, buffer 108, nonvolatile memory 109, host I/F 105 connected to the host-side system 102, and device I/F 106 connected to the semiconductor storage device 103.

The CPU 104 is connected via the host I/F 105 to the host-side system 102 and connected via the device I/F 106 to the semiconductor storage device 103, and performs a bridge process between the host-side system 102 and the semiconductor storage device 103.

The CPU 104 is also connected with the boot ROM 107, buffer 108, and nonvolatile memory 109. The boot ROM 107 stores a firmware for activating the CPU 104, and the nonvolatile memory 109 stores an address conversion table (described later) used for logical address conversion. The buffer 108 can temporarily store data that are read and written at the time of logical address conversion.

The semiconductor storage device 103 includes a flash memory controller 110 connected to the CPU 104 of the address conversion apparatus 101 via the device I/F 106, and a flash memory 111 connected to the flash memory controller 110. In accordance with instructions given from the host-side system 102, the flash memory controller 110 reads and writes data from and to the flash memory 111.

The flash memory controller 110 performs conversion/connection processing on logical block address and physical block address (hereinafter respectively referred to as the LBA and the PBA) by using a map (not shown) in the flash memory controller 110. More generally, the controller 110 performs conversion/connection processing on logical address and physical address.

The address conversion apparatus 101 is seen from the host-side system 102 as a device, and seen from the semiconductor storage device 103 as a host. It should be noted that the form of operation of the address conversion apparatus 101 is not limitative. For example, the address conversion apparatus 101 can be configured to operate as a filter for LBA conversion.

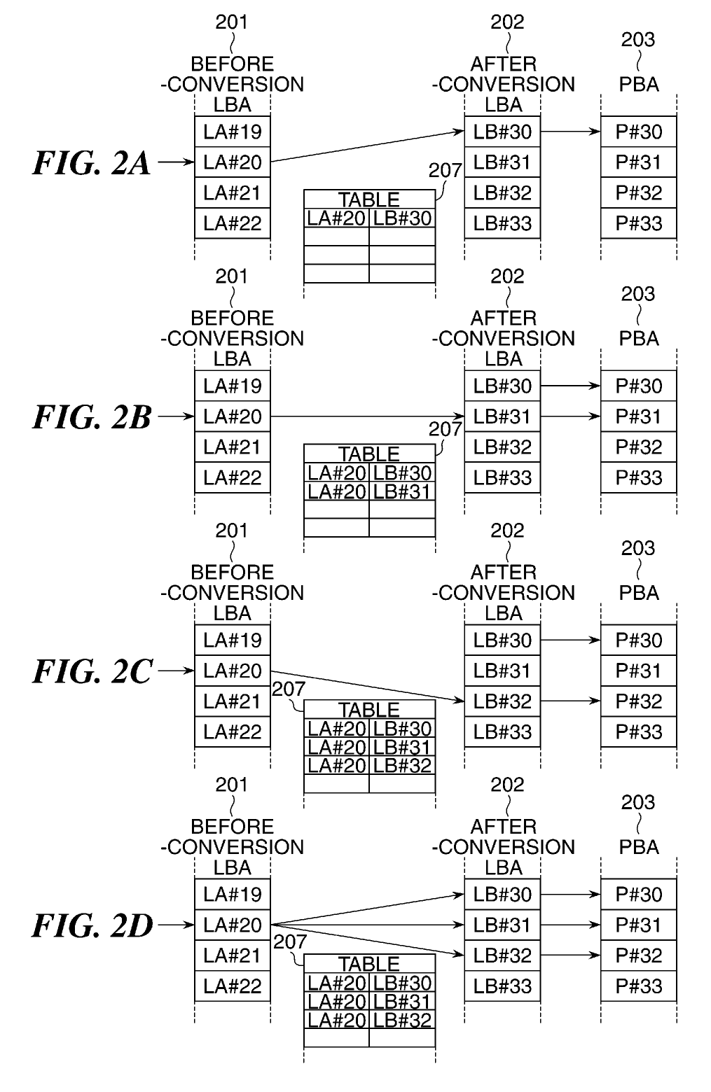

FIGS. 2A to 2D each show an address conversion table for use by the address conversion apparatus 101 and each show a correspondence relation among before- and after-conversion logical addresses on the file system and physical addresses of the flash memory 111.

In each of FIGS. 2A to 2D, reference numeral 201 denotes before-conversion logical addresses on the file system (hereinafter referred to as the before-conversion LBAs). Symbols LA#19, LA#20, etc. denote some of the before-conversion LBAs. A directional line entering LA#20 represents a write instruction or a delete instruction given from the system 102 to LA#20.

Reference numeral 202 denotes logical addresses that are converted from before-conversion LBAs by the address conversion apparatus 101 (hereinafter referred to as the after-conversion LBAs). Symbols LB#30, LB#31, etc. denote some of the after-conversion LBAs. A directional line extending from LA#20 to LB#30 in FIG. 2A represents that LA#20 is converted into LB#30 when the write instruction is given to LA#20 for the first time, a directional line extending from LA#20 to LB#31 in FIG. 2B represents that LA#20 is converted into LB#31 when the write instruction is given to LA#20 for the second time, and a directional line extending from LA#20 to LB#32 in FIG. 2C represents that LA#20 is converted into LB#32 when the write instruction is given to LA#20 for the third time. In FIG. 2D, directional lines extending from LA#20 to respective ones of LB#30, LB#31, and LB#32 represent that these three after-conversion LBAs (LB#30, LB#31, and LB#32) correspond to LA#20 to which the delete instruction is given after the data write instruction is given three times in total.

Reference numeral 203 denotes physical addresses (hereinafter referred to as the PBAs) of the flash memory 111 corresponding to after-conversion LBAs. Symbols P#30, P#31, etc. denote some of the PBAs. A directional line extending from LB#30 to P#30 in FIG. 2A represents that LB#30 corresponds to P#30, a directional line extending from LB#31 to P#31 in FIG. 2B represents that LB#31 corresponds to P#31, and a directional line extending from LB#32 to P#32 in FIG. 2C represents that LB#32 corresponds to P#32. In FIG. 2D, directional lines extending from LB#30, LB#31, and LB#32 to respective ones of P#30, P#31, and P#32 represent that LB#30, LB#31, and LB#32 respectively correspond to P#30, P#31, and P#32.

Reference numeral 207 denotes an address conversion table in which there is stored information about connection between each pair of before-conversion LBA and after-conversion LBA (i.e., address conversion information that associates one or more before-conversion LBAs with one or more after-conversion LBAs). The address conversion table 207 is for use by the address conversion apparatus 101 and stored and held in the nonvolatile memory 108.

In the address conversion table 207 of FIG. 2A, there is stored address conversion information that associates LA#20 (i.e., before-conversion LBA given with the write instruction for the first time) with LB#30 (i.e., after-conversion LBA converted from LA#20). In the address conversion table 207 of FIG. 2B, there is stored address conversion information that associates LA#20 (i.e., before-conversion LBA given with the write instruction for the second time) with LB#31 (i.e., after-conversion LBA converted from LA#20) in addition to the address conversion information that associates LA#20 with LB#30. In the address conversion table 207 of FIG. 2C, there is stored address conversion information that associates LA#20 (i.e., before-conversion LBA given with the write instruction for the third time) with LB#32 (i.e., after-conversion LBA converted from LA#20) in addition to the two pieces of address conversion information that associate LA#20 with respective ones of LB#30 and LB#31.

In the address conversion table 207 of FIG. 2D, there are stored three pieces of address conversion information observed when the delete instruction is given to LA#20 after the write instruction is given to LA#20 three times in total (which are the same as the three pieces of address conversion information stored in the address conversion table 207 of FIG. 2C).

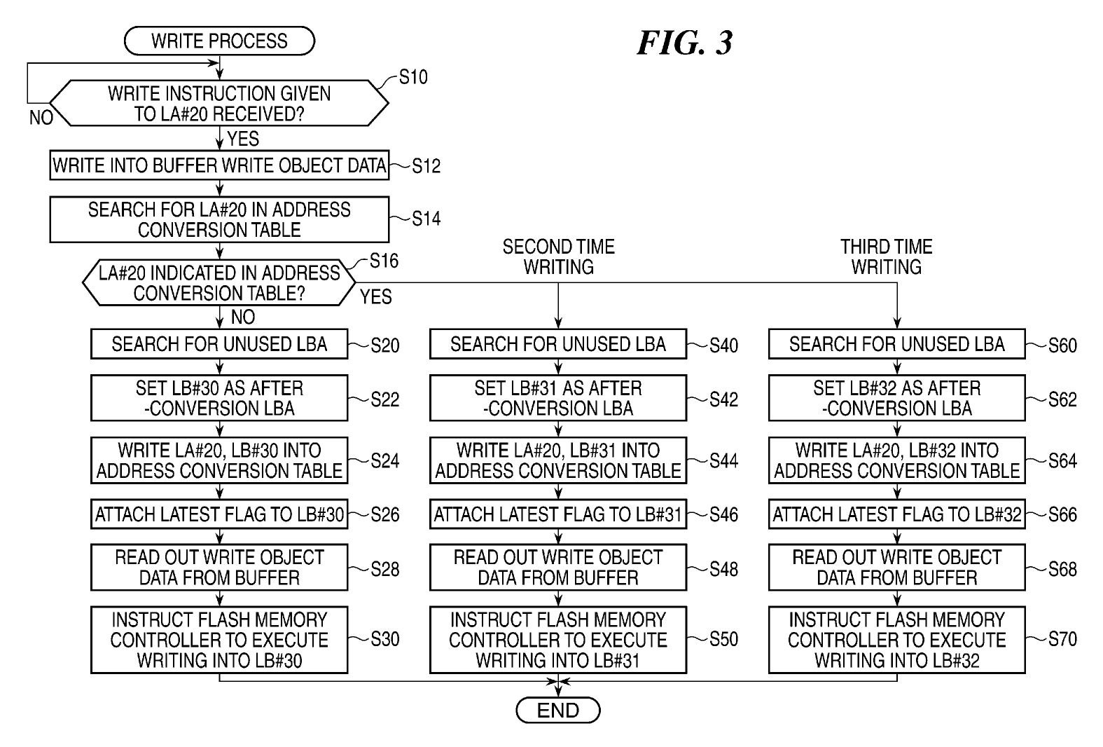

FIG. 3 shows, in flowchart, procedures of a write process performed by the CPU 104 of the address conversion apparatus 101.

In the write process shown in FIG. 3, the CPU 104 determines in step S10 whether or not it receives from the host-side system 102 a write instruction given to any of before-conversion LBAs (a write instruction to LA#20 in this example). When receiving the write instruction (i.e., if YES to step S10), the CPU 104 writes into the buffer 108 write object data received together with the write instruction (step S12), and searches for LA#20 in the address conversion table 207 (step S14).

Next, based on a result of the search in step S14, the CPU 104 determines whether or not LA#20 is already written and indicated in the address conversion table 207 (step S16). If LA#20 is not indicated in the table 207 (i.e., if NO to step S16), the CPU 104 searches for an unused LBA other than one or more after-conversion LBAs written in the address conversion table 207, and selects one (LB#30 in this example) of one or more unused LBAs found by the search (step S20).

Next, the CPU 104 sets LB#30 selected in step S20, as an after-conversion LBA (step S22), writes LA#20 and LB#30 (i.e., the before- and after-conversion LBAs) into the address conversion table 207 such that these LBAs are made to correspond to each other (step S24), and attaches the latest flag to LB#30 written into the table 207 (step S26).

Next, the CPU 104 reads out the write object data from the buffer 108 (step S28), instructs the flash memory controller 110 to execute writing into LB#30 (step S30), and completes the present process. The flash memory controller 110 determines P#30 as the PBA of the flash memory 111 that corresponds to LB#30 specified in step S30 by referring to the map in the controller 110, and writes into P#30 the write object data read out from the buffer 108 in step S28.

Subsequently, when again receiving from the host-side system 102 the write instruction given to LA#20 (i.e., if YES to step S10), the CPU 104 writes the write object data into the buffer 108 (step S12), and searches for LA#20 in the address conversion table 207 (step S14).

Since LA#20 was written into the address conversion table 207 in the previous write process, the CPU 104 determines in step S16 that LA#20 is already written and indicated at one place in the address conversion table 207. Thus, the process proceeds to step S40 via a “second time writing” branch.

In step S40, the CPU 104 searches for an unused LBA other than one or more after-conversion LBAs indicated in the address conversion table 207, and selects one (LB#31 in this example) of one or more unused LBAs found by the search. Next, the CPU 104 sets LB#31 selected in step S40 as an after-conversion LBA (step S42), writes LA#20 and LB#31 into the address conversion table 207 such they are made to correspond to each other (step S44), deletes the latest flag attached to LB#30 in the previous write process, and attaches the latest flag to LB#31 written in step S44 into the address conversion table 207 (step S46).

Next, the CPU 104 reads out the write object data from the buffer 108 (step S48), instructs the flash memory controller 110 to execute writing into LB#31 (step S50), and completes the present process. The flash memory controller 110 determines P#31 as the writing destination in the flash memory 111 that corresponds to LB#31 by referring to the map, and writes into P#31 of the flash memory 111 the write object data read out from the buffer 108 in step S48. Thus, wear leveling is performed in which data is written into P#31 different from the writing destination P#30 in the previous write process.

Subsequently, when receiving, from the host-side system 102, the write instruction given to LA#20 for the third time (i.e., if YES to step S10), the CPU 104 writes the write object data into the buffer 108 (step S12), and searches for LA#20 in the address conversion table 207 (step S14).

Since LA#20 was written twice into the address conversion table 207 in the write process performed twice, the CPU 104 determines in step S16 that LA#20 is already written at two places in the address conversion table 207. Thus, the process proceeds to step S60 via a “third time writing” branch.

In step S60, the CPU 104 searches for an unused LBA other than one or more after-conversion LBAs indicated in the address conversion table 207, and selects one (LB#32 in this example) of one or more unused LBAs found by the search. Next, the CPU 104 sets LB#32 selected in step S60 as an after-conversion LBA (step S62), writes LA#20 and LB#32 into the address conversion table 207 such they are made to correspond to each other (step S64), deletes the latest flag attached to LB#31 in the previous write process, and attaches the latest flag to LB#32 written in step S64 into the address conversion table 207 (step S66).

Next, the CPU 104 reads out the write object data from the buffer 108 (step S68), instructs the flash memory controller 110 to execute writing into LB#32 (step S70), and completes the present process. The flash memory controller 110 determines P#32 as the writing destination in the flash memory 111 that corresponds to LB#32 by referring to the map, and writes into P#32 of the flash memory 111 the write object data read out from the buffer 108 in step S68. Thus, wear leveling is performed in which data is written into P#32 different from the writing destinations P#30, P#31 in the previous write process performed twice.

It should be noted that the case has been described with reference to FIG. 3 where the write instruction is given three times to LA#20. Actually, however, the write instruction is given an arbitrary number of times to arbitrary before-conversion LBAs. Even in that case, it is enough to execute the same write process as that shown in FIG. 3.

In FIG. 3, the procedures for the case where the second time write instruction is given and the procedures for the case where the third time write instruction is given are separately described for ease of understanding. However, the procedures for these two cases are the same as each other except for the after-conversion LBA selected from unused LBAs. Thus, procedures to be performed in a case where the second and subsequent write instructions are given in succession can collectively be shown.

More specifically, each time the CPU 104 determines, in the determination executed in step S16 in response to the write instruction being given to any of before-conversion LBAs, that the before-conversion LBA is already described in the address conversion table 207, it is enough for the CPU 104 to execute the same processing as that in steps S40 to S50, while determining that the write instruction is given to the before-conversion LBA for the second or subsequent time.

According to the write process of FIG. 3, steps S22, S42 and S62 function as a conversion unit that converts a logical address (before-conversion LBA) given with the write instruction into another logical address (after-conversion LBA). In a case where the write instruction is given multiple times to the same logical address, the conversion unit converts the same logical address to a different logical address at each conversion.

Steps S24, S44 and S64 function as a holding unit for holding address conversion information that associates the logical address given with the write instruction with an after-conversion logical address converted from the first-mentioned logical address by the conversion unit. In a case where the write instruction is again given to the same logical address, the holding unit holds the address conversion information held in response to the previous write instruction, and also holds new address conversion information that associates the same logical address with an after-conversion logical address that is different from the after-conversion logical address indicated in the first-mentioned address conversion information. In other words, in a case where the write instruction is given multiple times to the same logical address, the holding unit holds plural pieces of address conversion information that associate the same logical address with respective ones of different after-conversion logical addresses.

Steps S30, S50 and S70 function as a write control unit for controlling the semiconductor storage device 103 to write data into a physical address of the flash memory 111 of the storage device 103 corresponding to the after-conversion logical address converted by the conversion unit from the logical address given with the write instruction.

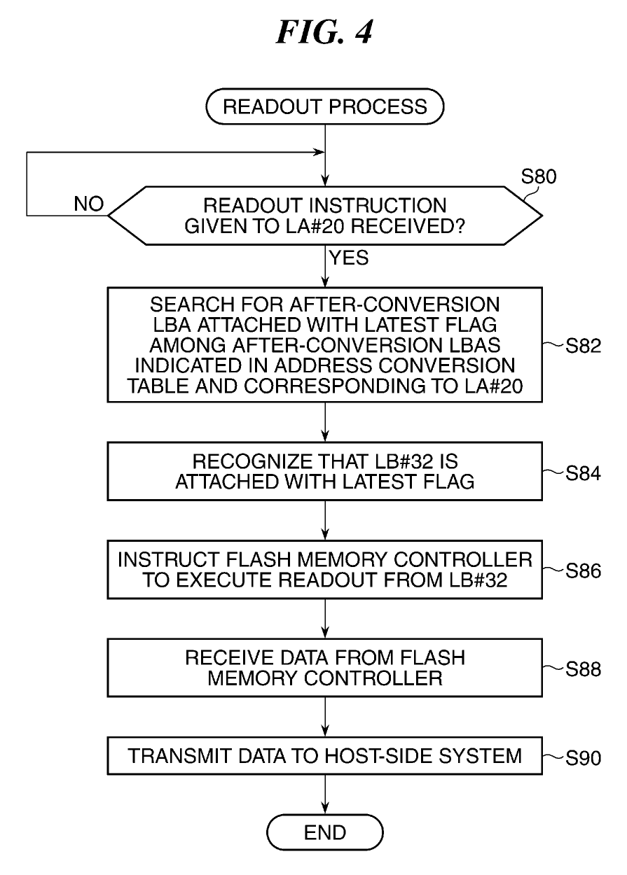

FIG. 4 shows, in flowchart, procedures of a readout process performed by the CPU 104 of the address conversion apparatus 101.

In the readout process of FIG. 4, when receiving from the host-side system 102 a readout instruction given to any of before-conversion LBAs (LA#20 in this example) (i.e., if YES to step S80), the CPU 104 searches for an after-conversion LBA attached with the latest flag among after-conversion LBAs indicated in the address conversion table 207 and corresponding to LA#20 (step S82). In this example, it is assumed that the latest flag is attached to LB#32.

Next, the CPU 104 recognizes that the latest flag is attached to LB#32 (step S84), and instructs the flash memory controller 110 to perform readout from LB#32 (step S86).

Next, the CPU 104 receives data transmitted from the flash memory controller 110 and read out by the controller 110 from P#32 of the flash memory 111 corresponding to LB#32 (step S88), and transmits the received data, as data from LA#20, to the host-side system 102 (step S90). Whereupon, the present process is completed.

It should be noted in a case where the readout instruction given to a before-conversion LBA other than LA#20 is received in step S80 of the readout process of FIG. 4, the same processing is performed as that when the readout instruction given to LA#20 is received.

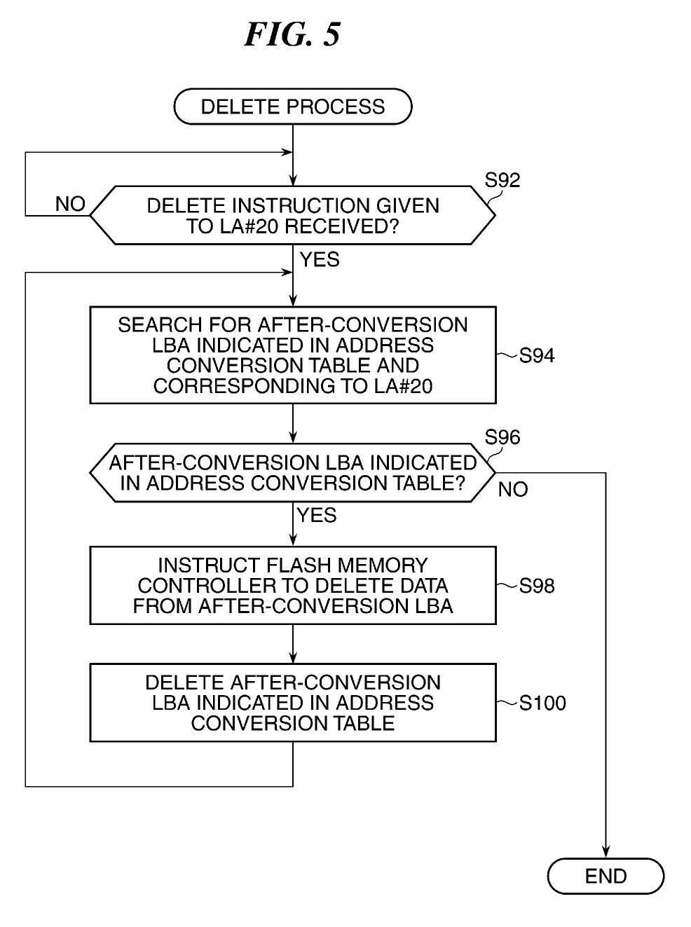

FIG. 5 shows, in flowchart, procedures of a delete process performed by the CPU 104 of the address conversion apparatus 101.

In the delete process of FIG. 5, when receiving from the host-side system 102 a delete instruction given to any of before-conversion LBAs, LA#20 in this example (i.e., if YES to step S92), the CPU 104 searches for an after-conversion LBA indicated in the address conversion table 207 and corresponding to LA#20 (step S94).

Next, the CPU 104 determines whether or not an after-conversion LBA corresponding to LA#20 is written and indicated in the address conversion table 207 (step S96). If the answer to step S96 is NO, the present process is completed. On the other hand, if one or more after-conversion LBAs corresponding to LA#20 are indicated in the table 207 (i.e., if YES to step S96), the CPU 104 instructs the flash memory controller 110 to delete data from a first one (e.g., LB#30) of the one or more after-conversion LBAs indicated in the address conversion table 207 (step S98). The flash memory controller 110 determines a PBA of the flash memory 111 (e.g., P#30) corresponding to the after-conversion LBA (e.g., LB#30) by referring to the map in the controller 110, and deletes data from the determined PBA. Next, the CPU 104 deletes the after-conversion LBA (e.g., LB#30) or information about connection between LA#20 and LB#30 indicated in the address conversion table 207 (step S100). Then, the process returns to step S94.

The CPU 104 again searches for, in step S94, an after-conversion LBA corresponding to LA#20 in the address conversion table 207, again determines in step S96 whether or not an after-conversion LBA corresponding to LA#20 is written and indicated in the table 207 based on a result of the search, and continues or completes to execute the present process in accordance with a result of the determination. In other words, the delete process of FIG. 5 is repeatedly executed until the last after-conversion LBA indicated in the address conversion table 207 is deleted.

In a case, for example, that LB#30, LB#31, and LB#32 each corresponding to LA#20 are written and indicated in the address conversion table 207 as shown in FIG. 2D, data is deleted from P#30 corresponding to LB#30, and LB#30 indicated in the table 207 is deleted. Then, data is deleted from P#31 corresponding to LB#31, and LB#31 indicated in the table 207 is deleted. Furthermore, data is deleted from P#32 corresponding to LB#32, and LB#32 indicated in the table 207 is deleted.

It should be noted in a case where the delete instruction given to a before-conversion LBA other than LA#20 is received in step S92 of the delete process of FIG. 5, the same processing is performed as that when the delete instruction given to LA#20 is received.

According to the delete process of FIG. 5, steps S94 to S100 function as a delete control unit that controls the semiconductor storage device 103 to delete data stored in a physical address corresponding to an after-conversion logical address converted from a logical address given with a delete instruction. In a case where plural pieces of address conversion information are held in the above-described holding unit, the delete control unit controls the semiconductor storage device 103 to delete pieces of data stored in respective ones of physical addresses respectively corresponding to different after-conversion logical addresses, which are respectively indicated in the plural pieces of address conversion information. It is therefore possible to properly delete pieces of data dispersedly stored in the semiconductor storage device 103 with wear leveling.

As described above, according to this embodiment, before- and after-conversion LBAs relating to logical address conversion performed prior to data writing to a PBA specified by wear leveling can be listed in the address conversion table 207 by the address conversion apparatus 101, which is interposed between the host-side system 102 and the semiconductor storage device 103. It is therefore possible to grasp all the addresses relating to the data writing.

In a case where the write instruction is given multiple times to the same LBA from the host-side system 102, the address conversion apparatus 101 gives an instruction to perform writing to a different LBA at each conversion. Thus, a plurality of PBAs are made to correspond to the same LBA in the LBA-PBA map provided in the flash memory controller 110 of the semiconductor storage device 103. In other words, the PBAs indicated in the map of the flash memory controller 110 and relating to data writing never be deleted by overwriting from the map. Thus, all the PBAs involved in the data writing can be grasped, and therefore, all the pieces of data relating to the delete instruction can be deleted from the flash memory 111 so as not to remain thereon.

Furthermore, the address conversion apparatus 101 operates independently of the semiconductor storage device 103, and does not hinder the flash memory controller 110 of the semiconductor storage device 103 from executing wear leveling. In addition, any existing semiconductor storage device can be used, if it has a compatible interface. This is advantageous for the user.

### Second Embodiment

In a second embodiment of this invention, the flash memory controller is configured to have a construction similar to that of the address conversion apparatus and achieve the address conversion function, unlike the first embodiment where the address conversion apparatus 101 having the address conversion function is provided independently of the semiconductor storage device 103 and the host-side system 102. In the following, a description of points common to the first and second embodiments will be omitted.

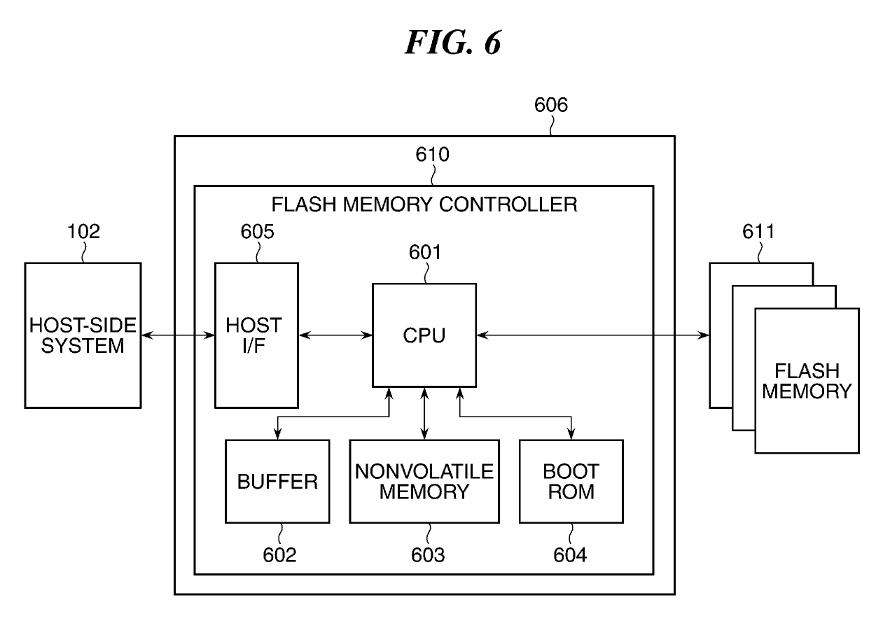

FIG. 6 schematically shows a storage control apparatus according to the second embodiment.

In FIG. 6, reference numeral 606 denotes an assembly of a flash memory controller 610 as a storage control apparatus and a flash memory 611 as a semiconductor storage device. The flash memory controller 610 includes a CPU 601 and includes a buffer 602, nonvolatile memory 603, boot ROM 604, and host I/F 605, which are connected to the CPU 601. The host-side system. 102 is connected to the host I/F 605, and the flash memory 611 is connected to the CPU 601.

The CPU 601 controls writing, reading, and deleting to and from the flash memory 611. The boot ROM 604 stores a firmware for starting the CPU 601, and the nonvolatile memory 603 stores the address conversion table 207 (see FIGS. 2A to 2D) for use in executing logical address conversion and a map for use in executing wear leveling. The buffer 602 is capable of temporarily storing data read and written at the time of logical address conversion.

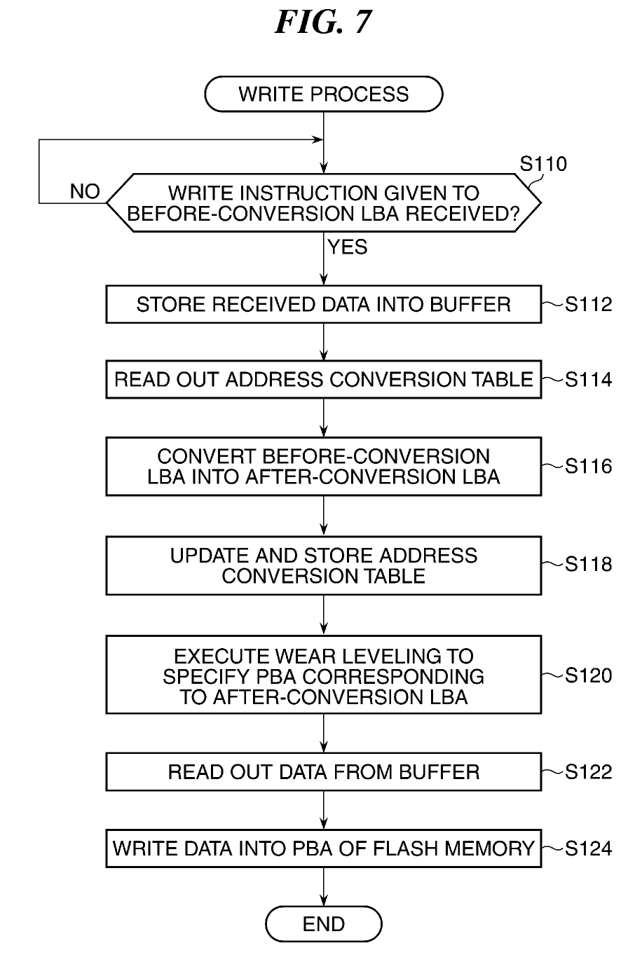

FIG. 7 shows, in flowchart, procedures of a write process performed by the CPU 601 of the flash memory controller 610.

In the write process of FIG. 7, when receiving, from the host-side system 102, a write instruction given to any of before-conversion LBAs (i.e., if YES to step S110), the CPU 601 stores data received together with the write instruction into the buffer 602 (step S112).

Next, the CPU 601 reads out the address conversion table 207 from the nonvolatile memory 603 (step S114), converts the before-conversion LBA given with the write instruction into an after-conversion LBA (step S116), writes the before- and after conversion LBAs into the address conversion table 207 to thereby update the table 207, and stores and holds the updated address conversion table 207 in the nonvolatile memory 603 (step S118).

Next, the CPU 601 executes wear leveling to specify a PBA of the flash memory 611 corresponding to the after-conversion LBA by referring to the map in the nonvolatile memory 603 (step S120), reads out data from the buffer 602 (step S122), and writes the data into the PBA of the flash memory 611 (step S124). Then, the present process is completed.

The processing from step S114 to step S118 of FIG. 7 is processing executed by the address conversion function of the flash memory controller 610.

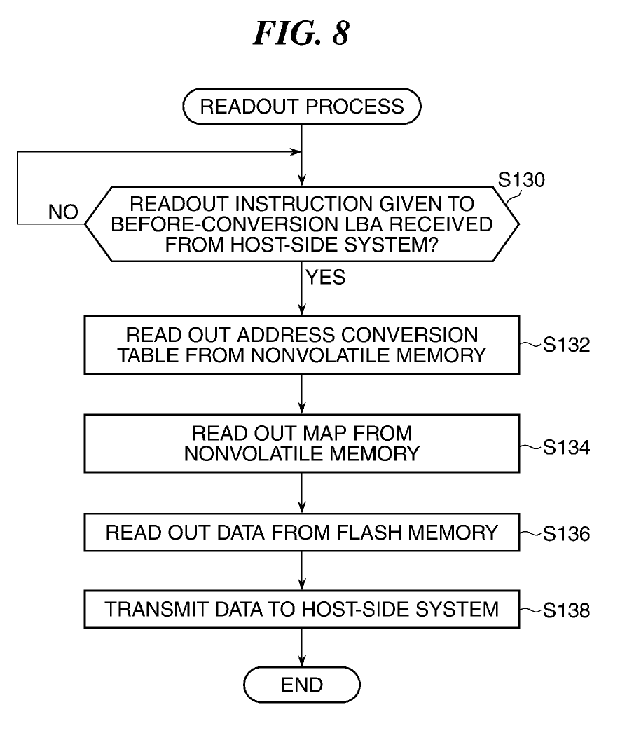

FIG. 8 shows, in flowchart, procedures of a readout process executed by the CPU 601 of the flash memory controller 610.

In the readout process of FIG. 8, when receiving, from the host-side system 102, a readout instruction given to any of before-conversion LBAs (step S130), the CPU 601 reads out the address conversion table from the nonvolatile memory 603 and obtains an after-conversion LBA corresponding to the before-conversion LBA by referring to the table (step S132).

Next, the CPU 601 reads out the map from the nonvolatile memory 603, and obtains a PBA of the flash memory 611 corresponding to the after-conversion LBA by referring to the map (step S134). The CPU 601 reads out data from the PBA of the flash memory 611 (step S136), and transmits the data to the host-side system. 102 (step S138), whereupon the present process is completed.

The processing in step S132 of FIG. 8 is processing executed by the address conversion function of the flash memory controller 610.

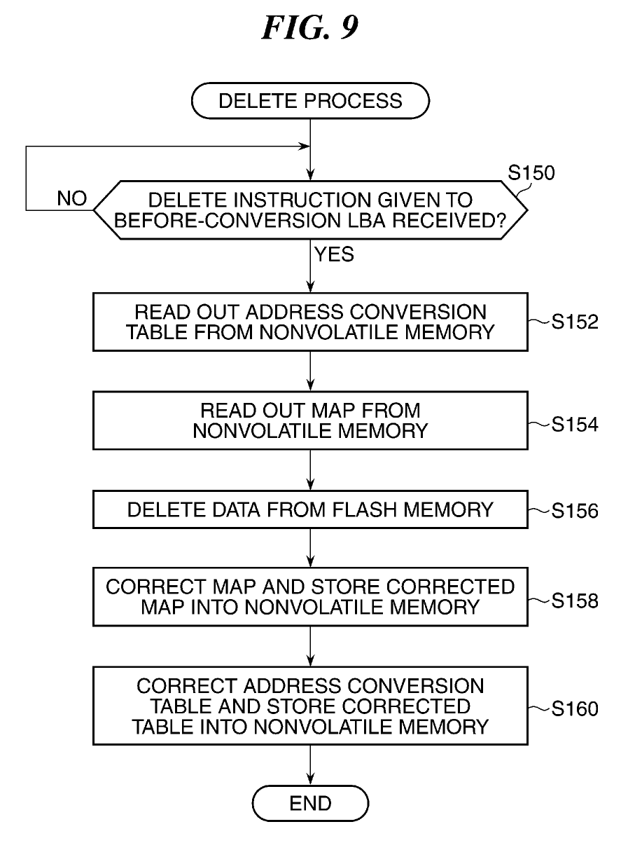

FIG. 9 shows, in flowchart, procedures of a delete process performed by the CPU 601 of the flash memory controller 610.

In the delete process of FIG. 9, when receiving, from the host-side system 102, a delete instruction given to any of before-conversion LBAs (step S150), the CPU 601 reads out the address conversion table 207 from the nonvolatile memory 603, and obtains one or more after-conversion LBAs corresponding to the before-conversion LBA by referring to the table 207 (step S152).

Next, the CPU 601 reads out the map from the nonvolatile memory 603, obtains one or more PBAs of the flash memory 611 corresponding to the one or more after-conversion PBAs by referring to the map (step S154), and deletes data from the one or more PBAs of the flash memory 611 (step S156). Next, the CPU 601 corrects the map according to the data deletion from the one or more PBAs in step S156, and stores the corrected map into the nonvolatile memory 603 (step S158). Finally, the CPU 601 corrects the address conversion table 207 such that one or more pieces of information about connection between the before- and after conversion LBAs relating to the delete instruction are deleted, and stores and holds the corrected table in the nonvolatile memory 603 (step S160).

The processing in steps S152 and S158 of FIG. 9 is processing executed by the address conversion function of the flash memory controller 610.

As described above, according to this embodiment, it is possible to delete all the pieces of data relating to the delete instruction from the flash memory 611 so as not to remain thereon by means of the flash memory controller 610 configured to have the address conversion function. Since the address conversion is executed by the flash memory controller 610, it is unnecessary to provide an address conversion apparatus between the host-side system and the semiconductor storage apparatus, whereby the construction can be simplified.

### Third Embodiment

In a third embodiment of this invention, unlike the first embodiment where the address conversion apparatus is provided independently of the semiconductor storage device and the host-side system, the CPU and memory of the host-side system are used instead of using the CPU and buffer of the address conversion apparatus, and the address conversion function is achieved by software running on the host-side system.

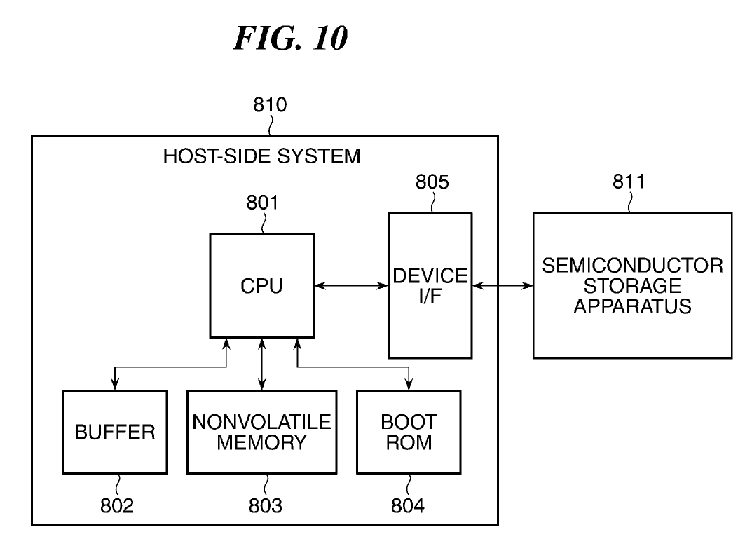

FIG. 10 schematically shows the construction of a storage control apparatus according to this embodiment.

In FIG. 10, reference numeral 810 denotes the host-side system as the storage control apparatus. The host-side system 810 includes a CPU 801 and includes a buffer 802, nonvolatile memory 803, boot ROM 804, and device I/F 805, which are connected to the CPU 801. A flash memory controller of a semiconductor storage device 811 is connected to the device I/F 805. The flash memory controller has a map for wear leveling and is connected to a flash memory. It should be noted that a chip set or a bridge IC may be disposed between the device I/F 805 and the flash memory controller.

The boot ROM 804 stores a firmware for starting the CPU 801, and the nonvolatile memory 803 stores and holds an address conversion table for use in executing logical address conversion. The buffer 802 is capable of temporarily storing data read and written at the time of logical address conversion.

At the time of data writing, the CPU 801 performs address conversion processing on a before-conversion LBA given with a write instruction to thereby obtain an after-conversion LBA. Next, the CPU 801 writes the before- and after-conversion LBAs into the address conversion table to update the table, stores and holds the updated address conversion table in the nonvolatile memory 803, and instructs, through the device I/F 805, the flash memory controller of the semiconductor storage device 811 to execute writing into the after-conversion LBA. In accordance with the write instruction, the flash memory controller determines a PBA of the flash memory corresponding to the after-conversion LBA by referring to the map, and writes data received from the CPU 801 into the determined PBA.

At the time of data readout, the CPU 801 reads out the address conversion table from the nonvolatile memory 803, and obtains, by referring to the table, an after-conversion LBA corresponding to a before-conversion LBA given with a readout instruction. Next, the CPU 801 instructs, through the device I/F 805, the flash memory controller of the semiconductor storage device 811 to read out data from the after-conversion LBA. In accordance with the readout instruction, the flash memory controller determines a PBA of the flash memory corresponding to the after-conversion LBA by referring to the map, reads out data from the determined PBA, and transmits the data to the host-side system 810.

At the time of data deletion, the CPU 801 reads out the address conversion table from the nonvolatile memory 803, and obtains, by referring to the table, an after-conversion LBA corresponding to a before-conversion LBA given with a delete instruction. Next, the CPU 801 instructs, through the device I/F 805, the flash memory controller of the semiconductor storage device 811 to delete data from the after-conversion LBA, deletes information about connection between before- and after-conversion LBAs from the address conversion table to thereby correct the table, and stores and holds the corrected table in the nonvolatile memory 803. In accordance with the delete instruction, the flash memory controller determines a PBA of the flash memory corresponding to the after-conversion LBA by referring to the map, deletes data from the determined PBA, and corrects the map.

The delete process is repeatedly executed until all the pieces of information about connection between the before-conversion LBA given with the delete instruction and respective ones of corresponding after-conversion LBAs are deleted from the address conversion table.

As described above, according to this embodiment, the host-side system 810 having the address conversion function is capable of deleting pieces of data relating to the delete instruction from the flash memory so as not to remain thereon. Since it is unnecessary to provide an address conversion apparatus, the construction can be simplified. Furthermore, an existing semiconductor storage device can be used, which provides cost advantages for the user.

### Fourth Embodiment

In a fourth embodiment of this invention, after-conversion LBA candidates are written in advance in an after-conversion LBA area of the address conversion table 207, whereby it becomes unnecessary to search for an unused LBA, unlike the first embodiment where an unused LBA is searched for in, e.g., step S20 of FIG. 3 at the time of address conversion.

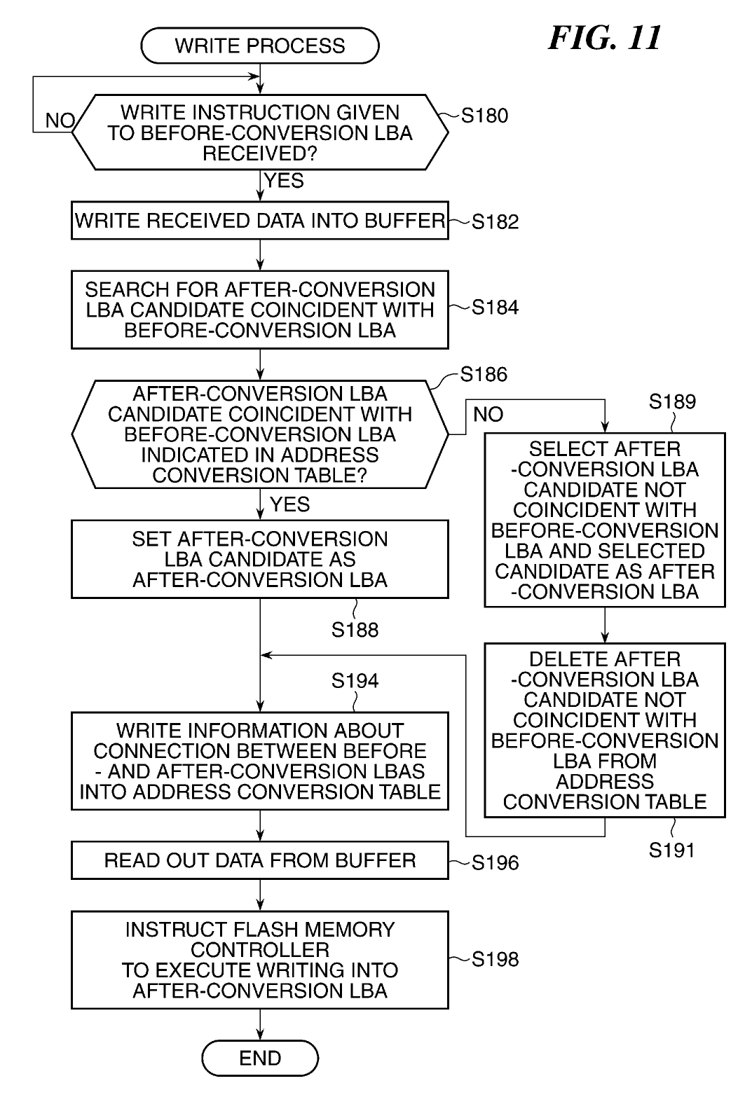

FIG. 11 shows, in flowchart, procedures of a write process executed by the CPU 104 of the address conversion apparatus 101 shown in FIG. 1.

Prior to executing the write process of FIG. 11, after-conversion LBA candidates are written into the after-conversion LBA area, which is reserved in advance in the address conversion table 207.

In the write process of FIG. 11, when receiving, from the host-side system 102, a write instruction given to any of before-conversion LBAs (i.e., if YES to step S180), the CPU 104 writes into the buffer 108 data received together with the write instruction (step S182), and searches for an after-conversion LBA candidate in the address conversion table 207, which coincides with the before-conversion LBA given with the write instruction (step S184).

Next, based on a result of the search in step S184, the CPU 104 determines whether or not an after-conversion LBA candidate coincident with the before-conversion LBA is written and indicated in the address conversion table 207 (step S186). If the answer to step S186 is YES, the CPU 104 selects the after-conversion LBA candidate from the address conversion table 207 and sets the selected candidate as an after-conversion LBA (step S188).

Next, CPU 104 writes information about connection between the before- and after-conversion LBAs into the address conversion table 207 (step S194), reads out data from the buffer 108 (step S196), and instructs the flash memory controller 110 to execute writing into the after-conversion LBA (step S198). Then, the present process is completed. In accordance with the write instruction, the flash memory controller 110 writes data into a PBA of the flash memory 111 corresponding to the after-conversion LBA.

On the other hand, if an after-conversion LBA candidate coincident with the before-conversion LBA is not indicated in the address conversion table 207 (i.e., if NO to step S186), the CPU 104 selects an after-conversion LBA candidate not coincident with the before-conversion LBA from among after-conversion LBA candidates indicated in the address conversion table 207, and sets the selected candidate as an after-conversion LBA (step S189).

Next, the CPU 104 deletes from the address conversion table 207 the after-conversion LBA candidate indicated in the table 207 and not coincident with the before-conversion LBA (step S191), and completes the present process.

As described above, according to this embodiment, since after-conversion LBA candidates are written in advance in the address conversion table, it is unnecessary for the CPU 104 to search for an unused LBA at the time of address conversion, thus making it possible to shorten processing time.

The address conversion table 207 can be held in, e.g., the nonvolatile memory 109, thereby making it possible to prevent the address conversion process from becoming non-executable when free space in the flash memory 111 of the semiconductor storage device 103 decreases.

Although a case has been described where the present embodiment is applied to the first embodiment, this embodiment is also applicable to each of the second and third embodiments.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-104365, filed May 9, 2011, which is hereby incorporated by reference herein in its entirety.

What is claimed is:

1. A storage control apparatus that controls data writing and deletion to and from a semiconductor storage device based on physical addresses in the semiconductor storage device and logical addresses made to respectively correspond to the physical addresses, comprising:
a conversion unit configured to convert a logical address given with a write instruction into another logical address, said conversion unit converting a same logical address to a different logical address at each conversion in a case where the write instruction is given multiple times to the same logical address;
a holding unit configured to hold address conversion information that associates the logical address given with the write instruction with an after-conversion logical address converted from the logical address by said conversion unit, said holding unit holding plural pieces of address conversion information that associate a same logical address with respective ones of different after-conversion logical addresses in a case where the write instruction is given multiple times to the same logical address;
a write control unit configured to control the semiconductor storage device to write data into a physical address corresponding to the after-conversion logical address converted by said conversion unit from the logical address given with the write instruction; and
a deletion control unit configured to control the semiconductor storage device to delete data stored in a physical address corresponding to an after-conversion logical address converted from a logical address given with a delete instruction, said delete control unit controlling the semiconductor storage device to delete pieces of data stored in respective ones of physical addresses respectively corresponding to different after-conversion logical addresses respectively indicated in plural pieces of address conversion information in a case where the plural pieces of address conversion information are held in said holding unit.

2. The storage control apparatus according to claim 1, wherein said conversion unit converts the logical address given with the write instruction into an unused logical address.

3. The storage control apparatus according to claim 1, wherein said conversion unit converts the logical address given with the write instruction into a logical address corresponding to a physical address that belongs to an unused area of the semiconductor storage device.

4. The storage control apparatus according to claim 1, wherein said holding unit stores and holds the address conversion information in the semiconductor storage device.

5. A storage control apparatus that controls data writing and deletion to and from a semiconductor storage device, comprising:
a conversion unit configured to convert an address given with a write instruction, among addresses representing storage areas of the semiconductor storage device, into another address;
a holding unit configured to hold address conversion information that associates the address given with the write instruction with an after-conversion address converted from the address by said conversion unit;
a write control unit configured to control the semiconductor storage device to write data into the after-conversion address converted by said conversion unit from the address given with the write instruction; and
a deletion control unit configured to control the semiconductor storage device in accordance with the address conversion information held by said holding unit to delete data stored in an after-conversion address associated with an address given with a delete instruction in a case where the delete instruction is given to the address previously given with the write instruction.

6. The storage control apparatus according to claim 5, wherein said conversion unit converts the address given with the write instruction into another unused address.

7. The storage control apparatus according to claim 5, wherein each time a write instruction is given to a same address, said conversion unit converts the same address to a different address.

8. The storage control apparatus according to claim 5, wherein in a case where a write instruction is given multiple times to a same logical address, said holding unit holds plural pieces of address conversion information that associate the same address with respective ones of different after-conversion addresses.

9. The storage control apparatus according to claim 8, wherein in a case where the plural pieces of address conversion information are held in said holding unit, said delete control unit controls the semiconductor storage device to delete pieces of data stored in the different after-conversion addresses respectively indicated in the plural pieces of address conversion information.

10. A control method for a storage control apparatus that controls data writing and deletion to and from a semiconductor storage device based on physical addresses in the semiconductor storage device and logical addresses made to respectively correspond to the physical addresses, comprising:
a conversion step of converting a logical address given with a write instruction into another logical address, a same logical address being converted into a different logical address at each conversion in said conversion step in a case where the write instruction is given multiple times to the same logical address;
a holding step of holding address conversion information that associates the logical address given with the write instruction with an after-conversion logical address converted from the logical address in said conversion step, plural pieces of address conversion information that associate a same logical address with respective ones of different after-conversion logical addresses being held in said holding step in a case where the write instruction is given multiple times to the same logical address;
a write control step of controlling the semiconductor storage device to write data into a physical address corresponding to the after-conversion logical address converted in said conversion step from the logical address given with the write instruction; and
a deletion control step of controlling the semiconductor storage device to delete data stored in a physical address corresponding to an after-conversion logical address converted from a logical address given with a delete instruction, the semiconductor storage device being controlled in said delete control step to delete pieces of data stored in respective ones of physical addresses respectively corresponding to different after-conversion logical addresses respectively indicated in plural pieces of address conversion information in a case where the plural pieces of address conversion information are held in said holding step.

11. A control method for a storage control apparatus that controls data writing and deletion to and from a semiconductor storage device, comprising:
a conversion step of converting an address given with a write instruction, among addresses representing storage areas of the semiconductor storage device, into another address;
a holding step of holding address conversion information that associates the address given with the write instruction with an after-conversion address converted from the address in said conversion step;
a write control step of controlling the semiconductor storage device to write data into the after-conversion address converted in said conversion step from the address given with the write instruction; and
a deletion control step of controlling the semiconductor storage device to delete data stored in an after-conversion address associated with an address given with a delete instruction in accordance with the address conversion information held in said holding step in a case where the delete instruction is given to the address previously given with the write instruction.

12. A non-transitory computer-readable storage medium storing a program for causing a computer to execute the control method as set forth in claim 10.

13. A non-transitory computer-readable storage medium storing a program for causing a computer to execute the control method as set forth in claim 11.
